(19) United States
(12) Patent Application Publication
(10) Pub. No.: US 2007/0263560 A1
(43) Pub. Date: Nov. 15, 2007

(54) Push-to-talk over cellular group set-up and handling using near field communication (NFC)

(76) Inventors: Mikko Saarisalo, Kantvik (FI); Jarkko Sevanto, Vantaa (FI); Pekka K. Viitaniemi, Espoo (FI); Simo Vahamottonen, Jarvenpaa (FI)

Correspondence Address: MORGAN & FINNEGAN, L.L.P., 3 World Financial Center, New York, NY, 10281-2101, US

(21) Appl. No.: 11/430,869

(22) Filed: May 10, 2006

(51) Int. Cl. H04Q 7/00

(52) U.S. Cl. 370/328; 370/401

(57) ABSTRACT

A system, apparatus and method for creating and managing group services in a cellular network for easy, fast and reliable connection of a subscriber(s) to one or more group services. A first terminal device stores service descriptions records for a first group of services in a cellular network. The first terminal is equipped with a communication module including a first RFID/NFC interface. A tangible object, typically a passive or semi-active tag with a RFID/NFC tag/transponder stores service description records for a first group of services. The first terminal is capable of initiating a new group of services group in the cellular network by way of communicating with the tangible object by touching the first RFID/NFC interface. A second communication module is capable of joining to the group of services group by way of reading the information from the tangible object over the second RFID/NFC interface upon touching the tangible object.

### RELATED APPLICATION

This application is related to application Ser. No. 10/785,025, entitled “ELECTRONIC PAYMENT SCHEME IN A MOBILE ENVIRONMENT FOR SHORT-RANGE E-COMMERCE: METHODS, SYSTEMS, APPARATUS AND PROGRAM PRODUCTS”, filed Feb. 26, 2004 (NC 28929) (4208-4169), assigned to the same assignee as that of the present invention.

### BACKGROUND OF INVENTION

1. Field of Invention

The present invention relates to group creation and Near Field Communication (NFC). More particularly, the invention relates to system, apparatus and methods for creating and managing Push-over-Cellular (PoC) groups with the aid of a Radio Frequency Identification( RFID)/ (NFC) communication interface.

2. Description of Prior Art

Push To Talk over Cellular (PoC) service is a two-way form of communications and is described in Open Mobile Alliance document OMA-RD-PoC-V1-20050329-C, dated Mar. 29, 2005. PoC allows users to engage in immediate communication with one or more users. PoC service is similar to a “walkie-talkie” application where a user presses a button to talk with an individual user or broadcast to a group of participants. The receiving participants hear the sender's voice either without any action on their part, for example, without having to answer the call or may be notified and has to accept the call before he can hear the sender's voice. Other participants can respond to this message once this initial speech is complete. The communication is half-duplex, that is to say, at most one person can talk at a time and all other participants hear the speech. This contrasts with voice calls, which are full duplex, where more than one person can talk at a time.

A mobile terminal equipped with a push to talk button allows push to talk applications including participation in PoC groups. The mobile terminal may include one dedicated button for each group. A group is set up upon request to a service provider by one or more PoC subscribers. The service provider sends an invitation to all group members. Upon acceptance of the invitation by the members, the service provider establishes a register in a communication server listing the group members with an assigned Id. The provider appoints a member of the group to serve as the Host or the provider serves as the Host by default. The Host has the authority to initiate and administrate an active group session in an on line fashion. A group member must program his/her terminal to identify the group members, their group Id and terminal address which can be very involved and error-prone for group communications. What is needed in the art is a simple, fast, reliable, error free mechanism, preferably by touching interaction between and among mobile terminals, for PoC set up and group communication, particularly when participating in multiple groups.

Prior art related to PoC setup for multiple group sessions includes:

(1) U.S. Pat. No. 6,757,531 discloses voice based communication between a number of mobile terminals of a telecommunication network, the method comprising the steps of creating a group of said number of terminals and storing group information in each of the number of terminals, recording a voice message in one of the terminals of the group, dispatching the voice message to the terminals of the group from the one of the terminals, and receiving the voice message at least all other terminals of the group. The step of creating a group of terminals further comprises the steps of coupling together a number of mobile terminals, initiating a group creation command from at least one of the terminals, sending predetermined information from terminal to terminal to each terminal of the number of terminals for forming a group information, and transmitting the group information to all of the terminals thus forming a group of the terminals.

(2) U.S. Pat. No. 6,982,961 discloses providing push-to-talk and push-to-conference functionality in a CDMA system. Participants, in one embodiment, may be divided into active and inactive participants with active participants assigned a private uplink/downlink channel pair by the communication system. Inactive participants may be assigned a public downlink channel. In one embodiment, silent active participants of a conference or talk session are timed out and the private uplink/downlink channel pair previously assigned to such individuals are released for use elsewhere in the network or by other members of the conference. In a push-to-talk embodiment one private uplink/downlink channel pair may at any given time be passed between the presently active members of the group.

(3) U.S. Pat. No. 6,970,727 discloses send, end, and push-to-talk functions of a combination cellular telephone/two-way radio, controlled with a single button on a hands-free device having a cable attached to the button, a microphone, and an earpiece. The button is pressed to instruct the cellular telephone/two-way radio to transmit in a half-duplex communications mode for a two-way radio conversation. The user speaks while continuing to press the button, to transmit the user's words in the two-way radio conversation. Next, the user releases the button, to instruct the cellular telephone/two-way radio to cease transmitting, to permit the user to hear words transmitted by the other party to the two-way radio conversation. Additionally, the user may answer an incoming cellular telephone call by pressing the button used during the two-way radio conversation, to instruct the cellular telephone/two-way radio to establish communications for a full duplex cellular telephone conversation.

(4) WO20055084059 discloses establishing a push-to-talk communication link in a GPRS radio communication system, whereby an access message (PTT request) of a first subscriber terminal (UE A) is received by a device (PTT Routing (UL), PTT agent (UL) in a base station system (BTSC, BSC). The at least one access message contains information relating to the first subscriber terminal and to at least one addressed second subscriber terminal (UE B), whereby the information is transmitted to an application server (PTT application server) by the device (PTT Agent (UL)), whereby resources for data transmission from or to the subscriber terminal (UE A) are assigned by the base station system (BTSC, BSC), and after reception of confirmation (PTT compressed notification), accessibility of at least one addressed second subscriber terminal (UE B), of the data from or to the first subscriber terminal device (UE A) is transmitted via assigned resources.

None of the cited art discloses a mobile terminal equipped with a radio frequency identification (RFID)/near field communication (NFC) interface means for creating and managing PoC communication groups more intuitively with the aid of RFID tags via the general concept of “touching” provided by the RFID/NFC interface.

### SUMMARY OF INVENTION

An apparatus for creating and managing group services in a cellular network for easy, fast and reliable connection of a subscriber (s) to one or more group services via a touching interaction between and among mobile terminal and RFID tags. A first terminal device stores service description records for a first group of services in a cellular network. The first terminal is equipped with a communication module including a first RFID/NFC interface. A tangible object, typically a passive or semi-passive tag, is equipped with a RFID/NFC tag/transponder and stores service description records for the first group of services. The first terminal is capable of initiating a new group of services group in the cellular network via touching the first RFID/NFC interface in the cellular network. The first terminal device further writes the specific information of the new group of services group to the tangible object. At least one second terminal device equipped with a second communication module includes a second RFID/NFC interface. The second communication module is capable of joining to the group of services group by way of reading the information for the tangible object over the second RFID/NFC interface upon touching the tangible object.

An aspect of the invention is a push-to-talk-over cellular (PoC) network using touch interaction between and among mobile terminals and a RFID tag via a RFID/NFC interface.

Another aspect is including (PoC) settings and configuration information in a RFID tag for transfer to a mobile terminal, enabling interactions with other mobile terminals in a PoC group or groups.

Another aspect is establishing PoC set up and configuration information in a server for transfer directly to each mobile terminal upon request, enabling participation of the mobile terminal in a PoC group or groups.

Another aspect is at least two terminal devices in touching relation for transferring PoC settings from one terminal device to the other terminal device without the use of a RFID tag.

Another aspect is a PoC enabled mobile terminal storing PoC setting and configuration information in a RFID tag via touching interaction between the terminal and the tag.

Another aspect is a data structure for PoC group settings in a RFID tag including (i) PoC server name, (ii) group identifier, (iii) group name, and (iv) tag initiating action.

Another aspect is storing PoC setting and configuration information in a RFID tag for at least two groups.

Another aspect is a group identifier in the configuration information stored in a RFID tag for group selection purpose by terminal devices.

Another aspect is a RFID tag object as a passive or semi active tag.

Another aspect is PoC enabled mobile devices for selecting among groups.

### DESCRIPTION OF DRAWINGS

The invention will be further understood from the following detailed description of a preferred embodiment, taken in conjunction with appended drawings, in which:

FIG. 1 is a representation of a cellular network providing group services to mobile terminals via touching an interface in a RFID/NFC tag, according to the principles of the present invention;

FIG. 2 is a representation of a PoC enabled mobile terminal according to one embodiment of the present invention operating in the cellular network of FIG. 1:

FIG. 3 is a representation of an exemplary RFID/NFC tag which interacts with the mobile terminals of FIG. 2;

FIG. 4 is a representation of a data structure stored in the RFID/NFC tag of FIG. 3 providing configuration information enabling a mobile device to participate in group sessions via touch interaction according to one embodiment of the present invention;

FIG. 5 is a representation of a user configuring initial PoC settings by touching a dedicated tag that already has necessary configuration information for setting up a PoC group according to one embodiment of the present invention;

FIG. 6 is a representation of a system in which a user writing a PoC group configuration to a tag / tags and sending / giving the tags over to his friends or contacts, the receivers of the tags configuring their terminals to join the PoC group by simply touching the tag with a RFID/NFC reader according to one embodiment of the present invention;

FIG. 7 is a representation of a system in which a user sharing his PoC group to peers by touching the phones together and giving the PoC group settings thereby providing direct PoC invitation without using tags according to one embodiment of the present invention;

FIG. 8 is a representation of a system in which a user selecting and activating a POC group by touching a tag or other phone according to one embodiment of the present invention; and

FIG. 9 is a representation of a system in which a user using a tag containing a PoC group configuration (group identifier as a minimum) as a tangent in his PoC communication, enabling communicating with several POC groups wherein a touch does the following: 1) selects a PoC group. 2) opens up the microphone while the tag is in the field according to one embodiment of the present invention.

### DESCRIPTION OF PREFERRED EMBODIMENT

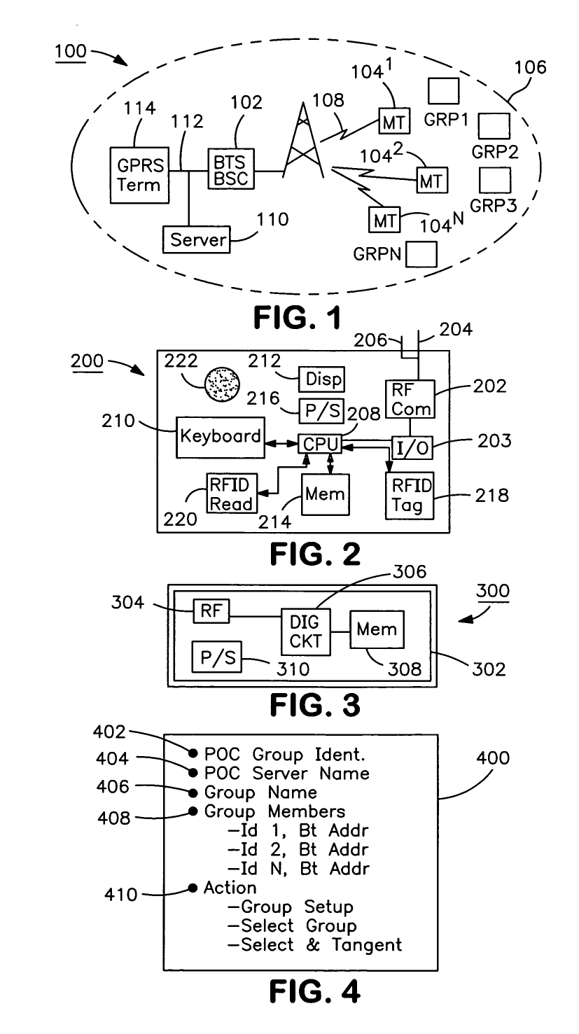

FIG. 1 discloses a PoC system 100 for creating and managing group services in a cellular network coupled to a Radio Frequency Identification (RFID)/Near Field Communication (NFC) environment, where RFID/NFC is for very short range two-way wireless connectivity using short-range radio frequency (RF) technology that allows a reader to read small amounts of data from other devices or tags when brought next to each other. The reading distance is typically within a few centimeters. NFC technology evolved from a combination of contactless identification or RFID (Radio Frequency Identification) and interconnection technologies. Touch-based interactions offer mobile phone users an intuitive and easy way to connect, collect and share data with other mobile devices and tags.

The PoC system includes a base station (BTS)/base station controller (BCS) 102, serving a plurality of PoC enabled mobile terminals 104¹ 104² and 104ⁿ, separately or within groups, e.g. group 1; group 2; group N, all within a BTS/BSC coverage area 106 via RF signals 108 transmitted by the base station and received from the mobile terminals. The base station is coupled to a communication server 110 for selecting and storing PoC set up and configuration information for the mobile terminals for group services. The base station is further connected to a cellular network 114, via a connection 112 which may be a for example a general packet radio system (GPRS) connection. The GPRS connection connects the mobile stations served by the base station 102 to a circuit switched network, and to other mobile terminals served by remote base stations connected to the cellular network. The cellular connected base stations allow mobile terminals served by different base stations to be in the same group. The GPRS network is described in detail in ETSI Standard, GSM 03.60 v6.2.0. GPRS is a packet-mode techniques used for transferring data and signaling. Alternatively, other cellular communications system may be coupled to the base station 102, for example, a global system mobile (GSM)

A mobile terminal can be a member of many different PoC groups. Each PoC group is assigned a group identifier (GID) by a service provider providing PoC service to the group. Thus, a mobile terminal may have many PoC group GIDs. To control the group membership of a mobile terminal, a database is created in the communication server 110 for the user. Typically, the group memberships are limited to five to ten groups per member. However, the database in the communication servers can also collect information of the membership of the users. Then all information regarding the users in the groups may be collected and stored in the communication server. The communication server activates the PoC group. The terminals can start to communicate with each other by transmitting data between pre-determining group members.

FIG. 2 is a functional representation 200 of a PoC enabled mobile terminal 104, shown in FIG. 1, according to one embodiment of the invention. PoC enabled mobile terminals are already commercially available, such as, for example Nokia 5140, 6170, 6260, 7270 cellular phone models. An RF communication unit 202 is linked to an antenna 204 for cellular communication with the GPRS or other cellular network in terms of messages and data using the protocols of the cellular network. The mobile terminal may also include a short-range communication antenna 206 coupled to the RF communication unit 204 for communication with other devices via a short-range communication network established within the coverage area 106 (See FIG. 1). The short-range communication network comprises according to non-limited embodiments of the present invention Bluetooth, Wi-Fi (IEEE 802.11x), Ultra Wideband (UWB) and Wireless USB (W-USB) networks. The RF communication unit 204 includes the necessary digital-to-analog and analog-to-digital conversion for voice/data transmission and reception. The RF communication 202 unit interacts with a CPU 208 via a standard I/O unit 203. The CPU also interacts with a keyboard 210 for means to a user for entering messages and data transmitted to other group members within the coverage area or transmitted over the cellular network. According to one embodiment of the present invention, the keyboard may include a dedicated PoC enabled button, capable of illumination when actuated, for one or each of the PoC communication groups. All interactions to a specific group may be controlled with the one button. With one button the user can form a group, send a voice message to a group, and listen to a message from a member of a group. Additional details regarding the keyboard are described in U.S. Pat. No. 6,757,531, assigned to the same assignee as that of the present invention and fully included herein by reference.

The messages and data transmitted to or received from the mobile terminals, alone or in groups are shown in a display 212 coupled to the CPU. A memory 214 comprising volatile and non-volatile storage contains programmed instructions for applications related to PoC set-up for (i) sending and listening to group messages or otherwise; (ii) operating systems; (iii) communication protocols necessary for creating and managing group services in a cellular network, and (iv) storing data and other information for operating the PoC system and devices. A power supply 216 provides the energy for operating the mobile terminal units. A microphone 222 is included in the terminal 200 for providing means for voice communications with other mobile terminals in a group or alone.

A RF-ID tag 218 may be installed in the terminal 200 according to embodiments of the present invention. According to one embodiment, the tag may be a passive device, which operates without an internal battery source, deriving the power to operate from the RF field 108 (See FIG. 1), which is inductively coupled to the passive tag. The passive tags are constrained in their capacity to store data and the ability to perform well in a noisy electromagnetic environment. Passive tags may contain varying amounts of information ranging from a small storage holding only an ID to 120 k byte memory sufficient to hold a serial identification number and parity bits. Alternatively, the RF-ID tag may be a semi-passive tag including a power supply and storage for processing the inductively coupled RF signal and transmitting stored signals or receiving transmitted signal at greater distances and data rates.

A RF-ID reader module 220 is installed in the mobile terminal and connected to the CPU. The reader module, using the power supply 216, transmits RF interrogation signals and receives responding RF signal from an external RF-ID tag (to be described in conjunction with FIG. 3) for processing tag data when within the coverage area of the mobile terminal. The RF signals are descriptive of the contents of the tag stored in a tag memory contained in the tag. The reader module 220 is capable of receiving a Bluetooth serial number and possible other information such as Bluetooth clock information, PoC setting and configuration information. According to one embodiment of the present invention, the reader module is capable of disabling the RF-ID tag 218, when sending interrogation signals to the external RF-ID tags.

In an alternative embodiment, the reader module 200 is capable of operating in an active communication mode with a reader module in another mobile device (not shown), in accordance with the interface and protocols described in Standard ECMA-340-Near Field Communication Interface and Protocol (NFCIP-1). During the active communication mode, one of the participating RFID tag readers simulates a RFID tag whereas the other one actively simulates a RFID tag reader. In contrast to passive RFID tags which are energized by the interrogation signal of the RFID tag reader, both participating RFID tag readers are always energized independently, i.e. have their own power supply to generate the radio/high frequency (RF/HF) signals used for data communications therebetween. Therefore, the RFID tag reader, which actively simulates a RFID tag, may be regarded as an active RFID tag. Alternatively, the reader provides radio frequency identification functionality also during unpowered conditions Additional details regarding RFID tag reader- RFID tag reader intercommunication is described in International Publication WO 2005/008575, published Jan. 27, 2005, assigned to the same assignee as that of the present invention and fully incorporated herein by reference.

Because of the data requirements for PoC group set up, FIG. 3 discloses an exemplary illustration of a semi-passive or active tag 300 as an external tag capable of handling the PoC data requirements when within the coverage area of the reader 220 (FIG. 2). An antenna film or coil 302 is inductively coupled to the reader and connected to a microchip (not shown) on the tag 300. The microchip includes an RF analog/digital circuit 304 for converting the RF interrogation signals transmitted by the RF-ID reader 220 (See FIG. 2) into digital signals for processing by digital circuitry 306. The processed digital signals representative of the interrogation signals, extract PoC set up or other information stored in an R/W memory 308 as a response to the interrogation signals for return to the reader 220 via the transmission signal path. The returned or response signals are stored in the memory 214 (FIG. 2) for further processing. The semi-passive tag 300 also communicates with the CPU 208 in the mobile terminals for updating information within the tag, e.g., clock offset information. Also, the tag may allow the RF-ID reader 220 (FIG. 2) to alter the data stored in the semi-passive tag by writing into and reading from the tag memory 308. The RF-ID tag 300 is powered by an internal battery 310, allowing greater communication range and higher data transmission rates.

FIG. 4 is a representation of a data structure for a PoC group set up according to one embodiment of the present invention. The data structure is stored in the communication server 119 (FIG. 1) by a service provider for each group member. The stored data is transferred to a mobile terminal upon request to a service provider, and stored in the mobile terminal tag 218 (FIG. 2). upon group set-up. Alternatively, in the case of RFID tag reader-RFID tag reader or active communication, the data structure can be stored in a memory included the active RFID reader or any other memory accessible by the active RFID reader module.

The stored data in the mobile terminal can be transferred to an external tag 300 using a write operation when the tag is within the range of a reader, as will be described hereinafter. The data structure includes, according to embodiments of the present invention a POC group identifier 402, assigned by a PoC service provider and installed in the communication server 110 (FIG. 1) by the provider in the establishment of a group. A PoC server name 404 is assigned by the provider. A group name 406 is assigned by the group requesting the establishment of the group. The group name is indicative of the service to be provided, e.g. family; friends; chat group, etc. A listing 408 provides the members group identifier (GID) and their Bluetooth (Bt) address. A listing 410 of group actions may further be provided, including group set up connections; mobile terminals forming a select group a keyboard button or tangent for selecting a group.

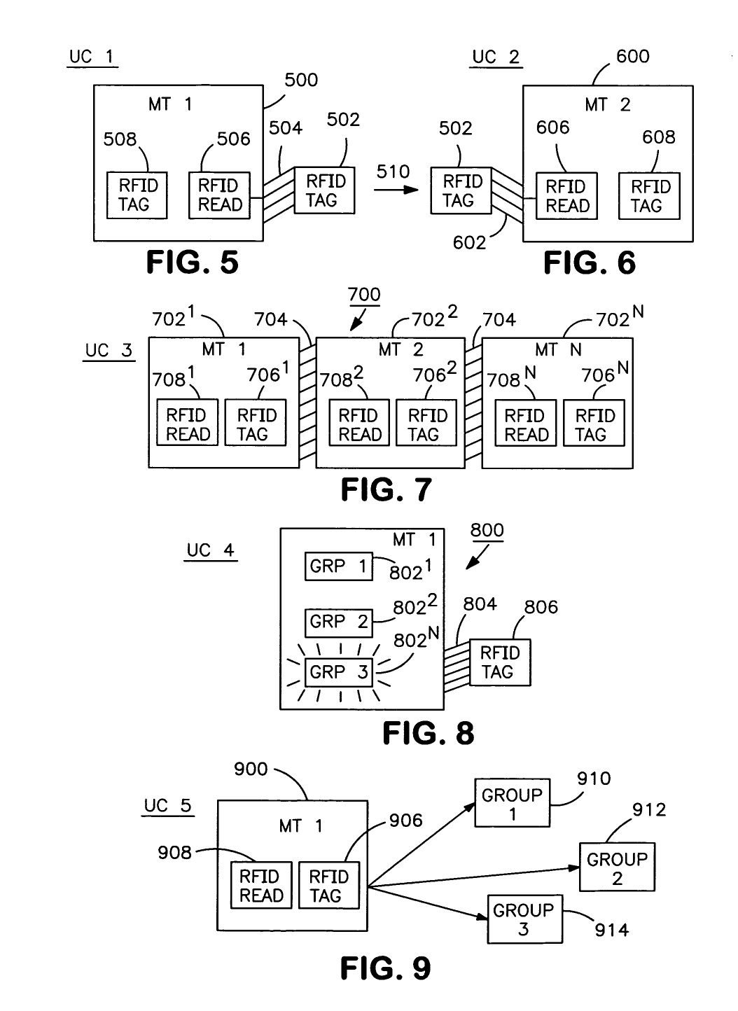

Representative PoC services provided by the present invention will be described in conjunction with FIGS. 5 through 9. The services include several exemplary scenarios including (a) setting up a PoC group device to device; (b) storing and reading PoC group settings into a NFC Tag, and (c). using an NFC tag as a PoC Group selection mechanism and as a tangent.

All the use cases described above can be implemented by a specific service record. The record can be stored into a tag or can be shared by device to device communication between mobile phones. In more specific terms, the service record can be implemented in a NDEF (-Nfc Forum Data Exchange Format ) (Former NTIP) record type standardized by the NFC Forum, 401 Edgewater Place, Suite 600, Wakefield, Mass. 01880, USA, and contains:

1. Action commands like: “PoC Server Setup”, “PoC Group setup”, “Select PoC Group”, “Tangent”; and

2. Action command related parameters.

Also combinations of the above can be formed. For instance, a Tangent Service record could be linked to “Select PoC Group”. Select PoC Group could again be linked to “PoC Group Setup”.

The data amount needed for providing the combinations indicated above is small enough to be read in one short go. The device may interpret touching of a tag as user pressing the tangent and keeping the tangent depressed for the duration of the touch. If the device does not have the right PoC group active before the touch, the named PoC group would be selected and activated before “pressing Tangent”. If the named POC group was not defined at all before the touch, the device configures the PoC group before selecting and activating it, and only after this it opens up the microphone.

To help users with PoC phones without NFC, the NFC enabled device would be capable of showing all necessary configuration information in order to manually perform the configurations to non-NFC phones if so needed.

FIG. 5 shows a mobile terminal 500 transferring PoC setup and configuration information 400 (FIG. 4) for a group, or several groups to a RF-ID or NFC tag 502 for distribution to other mobile terminals desirous of participating in a PoC group(s) according to one embodiment of the present invention. Multiple PoC set up and configuration information may be transferred by the tag 502 to serve many different interests of a user related to work, play, social, etc. The information to be transferred is obtained from a service provider via a communication server, as previously described. The RF-ID tag is in contiguous engagement or touches 504 the mobile terminal 500 for transfer of the information. A RF-ID reader 506 in the terminal 500 has access to the PoC setup and configuration information stored in the memory 214 (FIG. 2) of the mobile terminal 500 via the CPU 208 (FIG. 2). The tag information may also be stored in a tag 508. The reader transmits an interrogation signal to the tag 502 which utilizes energy of the signal and returns an acknowledgement signal to the reader. On receipt of the acknowledgement signal, the reader accesses the memory 214 (FIG. 2) and transmits the PoC set up and configuration information to the tag by way of a write operation while “touching” the tag. The tag 502 processes the PoC set up and configuration via the RF and digital circuits for storage in the memory 308 shown in FIG. 3. The transfer is typically completed almost instantly. A completion signal may be sent by the tag to the reader. The tag is removed from the mobile terminal 500 and is available to transfer the stored information to other devices capable of performing RFID read operation. The text RFID Handbook by K. Finkenzeller, published by John Wiley & Son, New York, N.Y., 1999, (ISBN 0-471-98851-000) Chapters 10 and 11 provides further details on the operation and construction of the reader and tag and is fully incorporated herein by reference. The information transfer between the mobile terminal 500 and the tag 502 is typically very fast, accurate, reliable and error free, enabling a user to set up or participate in a group or groups. The user is not involved in the transfer, except to keep the mobile terminal and tag in continuous engagement for an instant of time.

FIG. 6 discloses a physical transfer 510 of the tag 502 by the user to another user for installation of the PoC set up and configuration contained in the tag to a mobile terminal 600. The information transfer occurs by simply bringing a mobile terminal 600 within close proximity to/touching 602 the tag 502 with the mobile terminal 600. A RF-ID reader 606 while “touching” the tag transmits an interrogation signal which is recognized by the tag 502. A response signal is sent to the reader 604 by the tag 502. The tag 502 proceeds to access the PoC set up and configuration information in the memory 308 (FIG. 3) for processing by the digital and RF circuits for transmission to the mobile terminal 600. The reader, under control of a CPU 208 (FIG. 2), transfers the PoC set up and configuration to a memory 214 (FIG. 2) for subsequent installation in a tag 608 contained in the mobile terminal 600. Alternatively, in the case of active communication, the RFID reader 506 may transfer the information to the RFID reader 602 emulating a tag simply by bringing the reader 506 in close proximity to the reader 602.

Again, the transfer of the PoC set up and configuration information is fast, accurate, reliable and error free, enabling the user to set up or participate in a group or groups. The user is not involved in the transfer, except for touching together the tag and the mobile terminal for an instant.

FIG. 7 discloses an exemplary process 700 for transferring or installing single or multiple PoC set up and configuration information among a plurality of mobile terminals 702¹, 702², and 702^{N} with a touch 704, using the processes described in FIGS. 5 and 6 according to one embodiment of the present invention. More specifically, for example, PoC set up and configuration information obtained from a service provider or previously installed in a RF-ID tag, e.g. tag 706¹ from a reader 708¹ is transferred to a tag 702² via a reader 708² and installed in a tag 706² using the process described in FIG. 6. Again, almost instantly, the mobile terminals are activated to set up or participate in a PoC group or groups related to their interests. The multiple transfer of PoC groups and configuration information speeds up the process for the user obtaining the maximum benefit of their mobile terminal while preserving accuracy and reliability of use.

FIG. 8 discloses a mobile terminal 800 including a keyboard containing multiple contact buttons 8021, 802², and 802^{N}, each contact linked specifically to different group PoC settings stored in the memory of the mobile terminal according to one embodiment of the present invention. A group setting may be transferred to a RF-ID tag 806, after touching 804 the mobile terminal 800 while a user depresses a selected button or tangent 802 The group setting and configuration information for each button is stored in the memory 214 (FIG. 2) and transferred to the reader 220 for delivery to the RF-ID 804, according to the process described in FIG. 5. The contact may illuminate while the transfer occurs and become dark when the transfer is completed.

FIG. 9 discloses an exemplary embodiment of a mobile terminal 900 containing a reader 908 and a tag 906 linked to a PoC group configuration, and including at least a group identifier. The tag 906 serves as a button enabling the terminal 900 to communicate with PoC groups 904, 906 and 908 by touching a mobile terminal in a selected group. The touching opens the microphone 222 (FIG. 2) in the mobile terminal 900 and provides necessary configuration information for the mobile terminal to actively participate in a corresponding PoC group and/or operate as an active member of the group while the tag is in the field of the mobile terminal in the selected group.

It will be apparent to persons skilled in the relevant art that various changes in form and detail can be made therein without departing from the spirit and scope of the invention. Accordingly, the breadth and scope of the present invention should not be limited by any of the above-described exemplary embodiments, but should be defined only in accordance with the following claims and their equivalents.

We claim:

1. A system for creating and managing group services in a cellular network, comprising:
a first terminal device equipped with a communication module including a first RFID/NFC interface and a cellular network interface; and
a tangible object associated with a RFID/NFC tag/transponder capable of storing service description records for cellular network group communication services;
wherein the first terminal is capable of initiating a new cellular network group communication services group in the cellular network by way of communicating with the cellular network over the cellular network interface;
wherein the first terminal device further writes the service specific information of the new cellular network group communication services group to the tangible object for storing; and
at least one second terminal device equipped with a second communication module including a second RFID/NFC interface and a cellular network interface, wherein the second communication module is capable of joining to the cellular network group communication services group by way of reading the information stored in the tangible object over the second RFID/NFC interface upon being in close contact with the tangible object.

2. The system of claim 1 wherein the cellular network group communication service is a push-to-talk-over cellular (PoC) network service.

3. The system of claim 1 further comprises:
(PoC) settings included in the service descriptions.
at least two terminal devices in contiguous relation for transferring PoC settings from one terminal device to the other terminal device without the use of a tangible object.

4. The system of claim 2 further comprising:
a server in the PoC network for storing PoC group settings.

5. The system of claim 3 further comprises:
a data structure for PoC group settings in the tangible object including (i) PoC server name; (ii) group name, and (ii) tag initiating action.

6. The system of claim 2 further comprises:
a service record stored in the tangible object for managing group services; and
configuration information for at least one additional group stored in the tangible object.

7. The system of claim 6 further comprises:
a group identifier in the configuration information for group selection purpose by the first and second terminal devices.

8. The system of claim 1 wherein the tangible object is a RFID tag which serves as a tangent when communicating PoC information.

9. The system of claim 1 wherein the first and second terminal each include a RFID reader for active communication when in close proximity and wherein one reader serves as a tag.

10. A method for creating and managing group services in a cellular network, comprising:
generating service description records in a first terminal device for at least one group communication services group in a cellular network equipped with a communication module including a first RFID/NFC interface and a cellular network interface; and
storing the service description records for cellular network group communication services group in a tangible object with a RFID/NFC tag/transponder
wherein the first terminal is capable of initiating a new cellular network group communication services group in the cellular network by way of communicating with the cellular network over the cellular network interface;
wherein the first terminal device further writes the service specific information of the new cellular network group communication services to the tangible object; and
reading the specific information for the tangible object over a second RFID/NFC interface in at least one second terminal device equipped with a second communication module upon being in close contact with the tangible object, wherein the second communication module is capable of joining to the cellular network group communication services group.

11. The method of claim 10 herein the cellular network group communication service is a push-to-talk-over cellular (PoC) network.

12. The method of claim 10 further comprises:
transferring PoC settings to at least two terminal device in close proximity without the use of a tangible object.

13. The method of claim 12 wherein the tangible object is a RFID tag which serves as a tangent.

14. The method of claim 13 wherein the RFID tag touching the second terminal serves as a group selector and tangent.

15. A mobile terminal for creating and managing group services in a cellular network, comprising:
processor means for generating and storing service description records for at least one group communication services group in a cellular network; and
a communication module including a RFID/NFC interface for transferring the generated service description records to a receiver device for group communication by way of communicating with the receiver device via a RFID/NFC communication link.

16. The mobile terminal of claim 15 further comprising:
push-to talk over cellular (PoC) setup and configuration information included in the service descriptions.

17. The mobile terminal of claim 16 wherein the receiver device is a tangible object or a second mobile terminal.

18. The mobile terminal of claim 17 wherein the receiver device is a tangible object for receiving the PoC set-up and configuration information transferred to the tangible object by touching the mobile terminal.

19. The mobile terminal of claim 17 wherein the tangible object stores the service description records and a second mobile terminal is capable of receiving said service description records by way of communicating with the tangible object via a RFID/NFC communication link.

20. The mobile terminal of claim 15 wherein the mobile device is capable of initiating a new cellular network group communication services group in the cellular network by way of communicating with the cellular network over a cellular network interface.

21. A data structure in digitized format embodied in a computer readable medium for use in creating and managing group services in a cellular network providing PoC services, comprising
a first digital field providing a group identifier assigned by a PoC service provider;
a second digital field providing a group name assigned by a group requesting a service provider to establish a group;
a third digital field listing group members together with their group identifier and ad hoc network address provided by group members participating in the group; and
a fourth digital field listing group actions

22. The data structure of claim 21 further comprising:
a fifth digital field providing group set up connections.

23. The data structure of claim 21 further comprising:
a sixth digital field listing mobile terminals forming a select group.

24. The data structure of claim 21 further comprising:
a seventh digital field executable as a tangent for selecting a group.

25. A medium storing program instructions, executable on a computer system for creating and managing group services in a cellular network, the instructions performing the following steps:
generating service description records for at least one group of group communication services in a cellular network;
initiating a new cellular network group communication services group in the cellular network by way of communicating the service description records with the cellular network over the cellular network interface; and
storing the service description records for cellular network group communication in a tangible object by way of writing the group communication services group specific information to the tangible object via a RFID/NFC communication link so that the group communication services group specific information is accessible for other devices capable of reading the group communication services group specific information from the tangible object with a RFID/NFC interface for joining the cellular network group of communication services group 1.
